(19) United States
(12) Patent Application Publication
(10) Pub. No.: US 2026/0184000 A1
(43) Pub. Date: Jul. 2, 2026

(54) MULTI-LAYER CONSTRUCTION HAVING GOOD PROPERTIES FOR PRINTING

(71) Applicant: Covestro Deutschland AG, Leverkusen (DE)

(72) Inventors: Klas-Moritz Kossel, Dormagen (DE); Marieelen Oelkers, Gerdau (DE)

(21) Appl. No.: 19/132,012

(22) PCT Filed: Dec. 1, 2023
(86) PCT No.: PCT/EP2023/084017

§ 371 Date: May 22, 2025

(30) Foreign Application Priority Data
Dec. 5, 2022 (EP) 22211400.1

(51) Int. Cl. B29C 48/21; B29C 48/00; B29C 48/10; B29K 23/00; B29K 67/00; B29K 75/00; B29K 101/12; B29K 105/00; B29K 491/00

(52) U.S. Cl. CPC B29C 48/21; B29C 48/0023; B29C 48/022; B29C 48/10; B29K 2023/12; B29K 2067/003; B29K 2075/00; B29K 2101/12; B29K 2105/0032; B29K 2105/0067; B29K 2105/0097; B29K 2491/00; B29K 2995/0005; B29K 2995/0063; B29K 2995/0065; B29K 2995/007; B29K 2995/0081; B29K 2995/0097; B29K 2995/0098

(57) ABSTRACT

The invention relates to a multilayer construction having particular properties for printing with ink, comprising one or more carrier layers A. comprising ≥70% by weight of a polymer, based on the total weight of the carrier layer A., having a hardness in a range from 50 Shore D to 90 Shore D, wherein at least one of the one or more carrier layers is configured as outer layer A., and at least one polymer layer B. comprising at least one thermoplastic elastomer in an amount of ≥70% by weight based on the total weight of the carrier layer B., and to the production and use thereof.

The invention relates to a multilayer construction having particular properties for printing with ink, comprising one or more carrier layers A. comprising ≥70% by weight of a polymer, based on the total weight of the carrier layer A., having a hardness in a range from 50 Shore D to 90 Shore D, wherein at least one of the one or more carrier layers is configured as outer layer A., and at least one polymer layer B. comprising at least one thermoplastic elastomer in an amount of ≥70% by weight based on the total weight of the carrier layer B., and to the production and use thereof.

Known polymer films, as described in EP2181844A2, EP1404771 or U.S. Pat. No. 6,040,027, may be provided with a very wide variety of properties depending on their application. As miniaturization of electronic components and sensors is becoming increasingly common, especially in the medical and diagnostic market, there is a great need for polymer films that are suitable for this purpose. Thus, the polymer films should be printable with electrical conductor tracks without the films losing their properties and shape during printing, or else during further processing, where high thermal stresses as well compressive and shear forces occur. A disadvantage of many polymer films is that they do not retain their shape under the high thermal and compressive loads or cannot be separated after printing because they exhibit an excessively high adhesive force to their coextruded further film, as is the case in EP2181844A2.

It is accordingly an object of the present invention to provide a multilayer construction which at least partially minimizes at least one disadvantage of the prior art. It it is a further object of the invention to provide a multilayer construction which is suitable for medical applications. It is especially an object of the present invention to produce a multilayer construction that is low in migrating additives and comprises an elastic film with high breathability and good printability with electrically conducting inks. It is moreover an object of the invention to provide a multilayer construction which after printing exhibits low warping of the film(s) while nevertheless allowing good detectability of any carrier layer(s).

A first subject of the invention relates to a multilayer construction comprising at least the following layers:
A. one or more carrier layers A. comprising ≥70% by weight, preferably ≥80% by weight, particularly preferably ≥90% by weight, of a polymer, based on the total weight of the carrier layer A., having a hardness in a range from 50 Shore D to 90 Shore D, preferably of 55 Shore D to 85 Shore D, particularly preferably of 60 Shore D to 80 Shore D, measured according to DIN ISO 7619-1-2012-02, wherein at least one of the one or more carrier layers is configured as outer layer A.,
B. at least one polymer layer B. comprising at least one thermoplastic elastomer, preferably a thermoplastic polyurethane (TPE-U), in an amount of ≥70% by weight, preferably ≥80% by weight, particularly preferably ≥90% by weight, based on the total weight of the polymer layer B.,
C. optionally at least one hotmelt adhesive layer C. which is preferably arranged between the carrier layer A. and the polymer layer B.,
D. optionally at least one cover layer D. comprising ≥50% by weight, preferably ≥70% by weight, more preferably ≥80% by weight, particularly preferably ≥90% by weight, of a polypropylene based on the total weight of the cover layer D.,
E. optionally at least one further polymer layer E. comprising at least one thermoplastic elastomer, preferably a thermoplastic polyurethane (TPE-U), in an amount of ≥70% by weight, preferably ≥80% by weight, particularly preferably ≥90% by weight, based on the total weight of the polymer layer E.,
wherein the co-extruded multilayer construction has at least one, preferably at least two, more preferably at least three, particularly preferably all of the following properties:
(E1) a layer thickness of the carrier layer A. in a range from 30 to 200 μm, preferably from 40 to 150 μm, more preferably from >50 to 120 μm, particularly preferably from 55 to 110 μm, very particularly preferably from 60 to 100 μm,
(E2) a layer thickness of the polymer layer B. in a range from 30 to 200 μm, preferably from 40 to 150 μm, more preferably from >50 to 120 μm, particularly preferably from 55 to 110 μm, very particularly preferably from 60 to 100 μm,
(E3) a peel force between the carrier layer A. and one of the layers in contact with the carrier layer A. selected from the group consisting of the polymer layer B., the adhesive layer C. or the further polymer layer E. in a range from 0.01 N/cm to 0.1 N/cm, preferably 0.015 N/cm to 0.08 N/cm, more preferably from 0.02 to 0.07N/cm, particularly preferably from 0.025 to 0.06 N/cm,
(E4) a content of additives, for example waxes, adhesion promoters, dyes, in the carrier layer A. in a range from 0% to 15% by weight, more preferably from 0% to 12% by weight, particularly preferably from 0.1% to 10% by weight, in each case based on the total weight of the carrier layer A., wherein it is preferable when the multilayer construction has a content of waxes in a range from 0% to 4% by weight, preferably from 0.1% to 3.5% by weight, or a content of adhesion promoters in a range from 0 to 10% by weight, preferably from 0.1% to 8% by weight,
(E5) a content of additives in the polymer layer B., in particular selected from the group consisting of antiblocking agents, such as Acrawax™ C from Arxada, SUPER FLOSS E from Imerys or calcium stearate from SigmaAldrich, in an amount in a range from 0% to 10% by weight, preferably 0.5% to 9% by weight, more preferably 1% to 8% by weight, particularly preferably from 2% to 6% by weight, based on the total weight of the polymer layer B. and/or matting agents in an amount in a range from 0% to 20% by weight, preferably 1% to 18% by weight, particularly preferably from 5% to 15% by weight, based on the total weight of the polymer layer B., the multilayer construction particularly preferably comprising an antiblocking agent in an amount of 1% to 8% by weight and a matting agent in an amount of 5% to 15% by weight based on the total weight of the polymer layer B.,
(E6) a hardness of the polymer layer B. in a range from 60 Shore A to 55 Shore D, preferably 70 Shore A to 45 Shore D, particularly preferably 80 Shore A to 95 Shore A,
(E7) a water vapour permeability of at least the polymer layer B. of ≥80 g/m²d, preferably of ≥100 g/m²d, particularly preferably of ≥150 g/m²d,
(E8) a resistance of a 200 μm-wide conductor track strand produced according to process 1) of ≤10Ω, more preferably ≤5Ω, particularly preferably ≤2Ω.

The peel force/adhesion between carrier layer A. and polymer layer B. was measured on a strip width of 200 mm based on ASTM F88a.

Especial preference is given to a multilayer construction exhibiting the properties (E1) and (E2). Also preferred is a combination of the properties (E1) and (E2) with one of the properties (E3) to (E8), in particular the combination (E1), (E2) and (E3) or the combination (E1), (E2), (E3) and (E8).

It is preferable when the adhesion between the carrier layer A. and the adjacent layer selected from the group consisting of the polymer layer B., the adhesive layer C. or the further polymer layer E. becomes dimensionally stable after a heating/pressing/printing process but the carrier layer A. is nevertheless nondestructively detachable. This property is especially important if the multilayer construction is to be printed with a conductive ink without the polymer layer B. warping, tearing or changing shape in any other way. The carrier layer A. is therefore peeled off from the polymer layer B. only after the printing process.

The at least one carrier layer A. comprises the polymer in a range from 70% to 100% by weight, preferably in a range from 80% to 98% by weight, particularly preferably in a range from 90% to 95% by weight, based on the total weight of the respective carrier layer A. The polymer of the at least one carrier layer A. is preferably a thermoplastic material, in particular selected from the group consisting of a polyethylene (PE), a polypropylene (PP), a polyamide (PA), a polycarbonate (PC), a polyethylene terephthalate (PET) or a mixture of at least two thereof. The carrier layer A. particularly preferably comprises polypropylene (PP), polycarbonate (PC), polyethylene terephthalate (PET) or a mixture of at least two thereof in an amount of 70% to 100% by weight, preferably in a range from 80% to 98% by weight, particularly preferably in a range from 90% to 95% by weight, based on the total weight of the respective carrier layer A. The polymer of the at least one carrier layer A. is preferably selected from the group consisting of a polyethylene (PE), a polypropylene (PP), a polycarbonate (PC), a polyethylene terephthalate (PET) or a mixture of at least two thereof. It is particularly preferable when the carrier layer A. comprises polypropylene (PP), polycarbonate (PC), polyethylene terephthalate (PET) or a mixture of at least two thereof in an amount of 70% to 100% by weight, preferably in a range of 80% to 98% by weight, particularly preferably in a range of 90% to 95% by weight, based on the total weight of the respective carrier layer A.

The carrier layer preferably comprises a polypropylene in an amount of 70% to ≤100% by weight, more preferably of 80% to 95% by weight, based on the total amount of the carrier layer A.

The carrier layer A. preferably comprises at least two, more preferably at least three, plies of the respective polymer. It is preferable when the ply that comes into contact with a further layer of the multilayer construction during the extrusion process, such as polymer layer B. or adhesive layer C., comprises the abovementioned additives. The plies that do not come into contact with other layers of the multilayer construction preferably comprise no additives.

It is preferable when the carrier layer A. comprises two plies containing 100% by weight of polypropylene and a ply containing 100% by weight of polyethylene, wherein the ply containing the polyethylene comes directly into contact with the polymer layer B. The ply containing polyethylene preferably has a thickness in a range from 2 to 50 μm, more preferably from 5 to 30 μm, particularly preferably from 10 to 20 μm.

The at least one polymer layer B. comprises a thermoplastic elastomer, preferably a thermoplastic polyurethane. The polymer layer B. comprises the thermoplastic elastomer in an amount of ≥70% by weight, preferably of ≥75% by weight, more preferably of ≥80% by weight, more preferably of ≥85% by weight, more preferably of ≥90% by weight, most preferably in a range from 70% to 95% by weight, based on the total weight of the polymer layer B.

Thermoplastic elastomers are materials containing elastomeric phases in thermoplastically processible polymers in either physically mixed-in or chemically incorporated form. A distinction is made between polyblends in which the elastomeric phases are physically mixed in and block copolymers in which the elastomeric phases are part of the polymer skeleton. As a result of the structure of the thermoplastic elastomers, hard and soft regions are present next to each other. The hard regions form a crystalline network structure or a continuous phase the interstices of which are filled with elastomeric segments. Because of this structure, these materials have rubber-like properties.

The thermoplastic elastomer is preferably selected from the group consisting of a thermoplastic copolyamide (TPE-A), in particular a polyether block amide, a thermoplastic polyurethane (TPE-U), a thermoplastic polyester elastomer (TPE-E), a styrene block copolymer (TPE-S), TPE-V —vulcanized (crosslinked) PP/EPDM compounds or a mixture of at least two thereof.

The thermoplastic copolyamide (TPE-A) may be any copolyamide that a person skilled in the art would select for a layer construction, in particular polyether block amides (PEBAs). Preferred polyether block amides are for example those consisting of polymer chains formed from repeating units corresponding to formula (0)

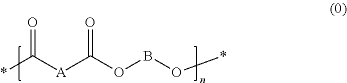

in which
A is the polyamide chain derived from a polyamide having 2 carboxyl end groups via the loss of the latter and
B is the polyoxyalkylene glycol chain derived from a polyoxyalkylene glycol having terminal OH groups via the loss of the latter, and
n is the number of units forming the polymer chain. The end groups here are preferably OH groups or moieties of compounds which terminate the polymerization.

The dicarboxylic polyamides having the terminal carboxyl groups are obtained in a known way, for example by polycondensation of one or more lactams and/or one or more amino acids, or also by polycondensation of a dicarboxylic acid with a diamine, in each case in the presence of an excess of an organic dicarboxylic acid preferably having terminal carboxyl groups. These carboxylic acids become part of the polyamide chain during the polycondensation and undergo addition in particular at the ends of this chain, as a result of which a polyamide having μ-dicarboxylic acid functionality is obtained. The dicarboxylic acid also acts as a chain terminator, which is why it is also used in excess.

The polyamide can be obtained proceeding from lactams and/or amino acids having a hydrocarbon chain consisting of 4-14 carbon atoms, for example from caprolactam, enantholactam, dodecalactam, undecanolactam, decanolactam, 11-aminoundecanoic or 12-aminododecanoic acid.

Examples of polyamides, as formed by the polycondensation of a dicarboxylic acid with a diamine, include the condensation products of hexamethylenediamine with adipic acid, azelaic acid, sebacic acid and 1,12-dodecanedioic acid, and the condensation products of nonamethylenediamine and adipic acid.

Useful dicarboxylic acids for the synthesis of the polyamide, i.e. firstly used for fixing one carboxyl group to each end of the polyamide chain and secondly as chain terminator, include those having 4-20 carbon atoms, in particular alkanedioic acids, such as succinic acid, adipic acid, suberic acid, azelaic acid, sebacic acid, undecanedioic acid or dodecanedioic acid, and additionally cycloaliphatic or aromatic dicarboxylic acids such as terephthalic acid or isophthalic acid or cyclohexane-1,4-dicarboxylic acid.

The polyoxyalkylene glycols having terminal OH groups are unbranched or branched and have an alkylene radical having at least 2 carbon atoms. In particular, these are polyoxyethylene glycol, polyoxypropylene glycol and polyoxytetramethylene glycol, and copolymers thereof.

The average molecular weight of these OH group-terminated polyoxyalkylene glycols can vary within a wide range; it is advantageously between 100 and 6000 g/mol, in particular between 200 and 3000 g/mol.

The proportion by weight of the polyoxyalkylene glycol, based on the total weight of the polyoxyalkylene glycol and dicarboxylic polyamide used to produce the PEBA polymer, is preferably 5-85% by weight, preferably 10-50% by weight.

Processes for synthesizing such PEBA polymers are known from FR Patent 7 418 913, DE-A 28 02 989, DE-A 28 37 687, DE-A 25 23 991, EP-A 095 893, DE-A 27 12 987 and DE-A 27 16 004.

Suitable and preferably suitable PEBA polymers are available for example under the trade names PEBAX, from Atochem, Pebax® 5010, Pebax® 5020, Pebax® 5030, Pebax® 5040, Pebax® 5070 from Arkema (Germany), Vestamid from Hüls AG, Grilamid from EMS-Chemie and Kellaflex from DSM.

Preferred polyether block amides may also contain the additives customary for plastics. Examples of typical additives include pigments, stabilizers, flow agents, lubricants and demoulding agents.

Examples of thermoplastic copolyamides which may be mentioned include products such as Pebax® 5010, Pebax® 5020, Pebax® 5030, Pebax® 5040, Pebax® 5070 from Arkema (Germany). Examples of thermoplastic polyurethanes are given below.

The thermoplastic polyester elastomer (TPE-E) can be any polyester elastomer that a person skilled in the art would select for a layer structure; the polyester elastomers are preferably copolyesters. Suitable copolyesters (segmented polyester elastomers) are formed, for example, from a large number of repeating short-chain ester units and long-chain ester units which are combined by ester bonds, where the short-chain ester units make up about 15-65% by weight of the copolyester and have the formula (I):

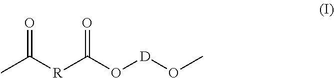

in which
R is a divalent dicarboxylic acid moiety which has a molecular weight of less than about 350 g/mol,
D is a divalent organic diol moiety which has a molecular weight of less than about 250 g/mol, the long-chain ester units make up about 35-85% by weight of the copolyester and have the formula (II)

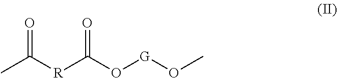

in which
R is a divalent dicarboxylic acid moiety which has a molecular weight of less than about 350 g/mol,
G is a divalent long-chain glycol moiety which has an average molecular weight of about 350 to 6000 g/mol. Examples of thermoplastic polyester elastomers (TPE-E) are DuPont™ Hytrel® 5556 or DuPont™ Hytrel® PC966 NC010 (DuPont, Wilmington, DE 19880-0709).

The copolyesters which can preferably be used can be prepared by copolymerizing a) one or more dicarboxylic acids, b) one or more linear, long-chain glycols and c) one or more low molecular weight diols.

The dicarboxylic acids for the production of the copolyester are preferably aromatic acids having 8-16 carbon atoms, in particular phenylenedicarboxylic acids such as phthalic, terephthalic and isophthalic acid.

The low molecular weight diols for the reaction to form the short-chain ester units of the copolyesters preferably belong to the classes of acyclic, alicyclic and aromatic dihydroxy compounds. The preferred diols have 2-15 carbon atoms, such as ethylene, propylene, tetramethylene, isobutylene, pentamethylene, 2,2-dimethyltrimethylene, hexamethylene and decamethylene glycols, dihydroxycyclohexane, cyclohexanedimethanol, resorcinol, hydroquinone and the like. Bisphenols for the present purpose include bis(p-hydroxy)diphenyl, bis(p-hydroxyphenyl)methane, bis(p-hydroxyphenyl)ethane and bis(p-hydroxyphenyl)propane.

The long-chain glycols used to produce the soft segments of the copolyesters preferably have molecular weights of about 600 to 3000 g/mol. These include poly(alkylene ether)glycols in which the alkylene groups have 2-9 carbon atoms.

Glycol esters of poly(alkylene oxide)dicarboxylic acids or polyester glycols can also be used as long-chain glycol.

The long-chain glycols also include polyformals, which are obtained by reacting formaldehyde with glycols. Polythioether glycols are also suitable. Polybutadiene glycols and polyisoprene glycols, copolymers of the same, and saturated hydrogenation products of these materials are satisfactory long-chain polymeric glycols.

Processes for synthesizing such copolyesters are known from DE-A 2 239 271, DE-A 2 213 128, DE-A 2 449 343 and U.S. Pat. No. 3,023,192.

The copolyesters can also contain the additives which are customary for plastics. Examples of typical additives are lubricants, such as fatty acid esters, metal soaps thereof, fatty acid amides and silicone compounds, antiblocking agents, inhibitors, stabilizers against hydrolysis, light, heat and discoloration, flame retardants, dyes, pigments, inorganic or organic fillers, and reinforcers. Reinforcers are especially fibrous reinforcing materials, for example inorganic fibres which are produced according to the prior art and may also have been sized. Further information about the auxiliaries and additives mentioned may be found in the specialist literature, for example J. H. Saunders, K. C. Frisch: “High Polymers”, volume XVI, Polyurethane, part 1 and 2, Interscience Publishers 1962 and 1964, R. Gächter, H. Müller (Ed.): Taschenbuch der Kunststoff-Additive, 3rd edition, Hanser Verlag, Munich 1989, or DE-A 29 01 774.

The thermoplastic styrene block copolymer (TPE-S) can be any styrene block copolymer that a person skilled in the art would select for a layer structure. The styrene-butylene block copolymers which can preferably be used consist of a polyethylene-butylene rubber middle block with a polystyrene end block chemically coupled at both ends. The polystyrene content is less than 30%.

The polystyrene end blocks are uniformly distributed as spherical polystyrene domains in the ethylene rubber matrix.

Processes for synthesizing suitable styrene block copolymers are known, for example, from U.S. Pat. No. 3,485,787, 4,006,116 and 4,039,629.

The styrene block copolymers can also contain the additives which are customary for plastics. Examples of typical additives include pigments, stabilizers, flow agents, lubricants and demoulding agents.

Examples of styrene block copolymers (TPE-S) are Elastron G, such as Elastron G100 and G101, Elastron D, such as Elastron D100 and D101 from Elastron (Turkey) and Kraton™ D SIBS from Kraton Polymers (USA), Septon™, especially Septon™ Q1250 or Septon™ V9461 from Kuraray (Japan), Styroflex® 2G66 from Ineos Styrolution Group GmbH (Germany), Thermolast® K from Kraiburg TPE (Germany) and Saxomer® TPE-S from PCW GmbH (Germany). Further suitable styrene-butylene block copolymers are available, for example, under the trade names ‘Kraton G and’Elexar from Shell Chemie GmbH.

The thermoplastic, vulcanized (crosslinked) PP/EPDM compound can be any PP/EPDM compound that a person skilled in the art would select for a layer structure. Examples of PP/EPDM compounds are Santoprene (from Exxon Mobil) or Sarlink (from DSM).

The preferably hydrophilic TPE-U are formed from alternating blocks of soft and hard segments, wherein the soft segments are formed from difunctional polyols constructed from polymerized ethers and/or esters and wherein the hard segments are formed from the reaction products of low molecular weight diols, i.e. the chain extender, and diisocyanates. These blocks are advantageously bonded to one another such that the hard segment in each case forms the two ends of the molecular chain and optionally the reactive isocyanate groups at the ends of the linear molecule are cappable with alcohols.

The multilayer construction preferably comprises one or more layers of TPE-U as polymer layer(s) B. whose soft segment phase is predominantly formed either from polyether soft segment units or from polyester soft segment units. The at least one polymer layer B. preferably comprises the TPE-U in an amount in a range from ≥70% by weight to 100% by weight, more preferably in a range from ≥80% by weight to 98% by weight, particularly preferably ≥90% by weight to 95% by weight, based on the total weight of the polymer layer B.

Depending on the organic diisocyanates employed, TPE-U may have aliphatic or aromatic character. It is preferable when aromatic diisocyanates are concerned. TPE-U typically have a block or segment construction. A basic distinction is made between hard segments and soft segments. Hard segments are formed from the organic diisocyanates used for reaction and short-chain compounds having two to three hydroxyl, amino, thiol or carboxyl groups, preferably compounds having two hydroxyl, amino, thiol or carboxyl groups, particularly preferably diols, having an average molecular weight of 60 to 500 g/mol. Soft segments are formed from the organic diisocyanates used for reaction and long-chain compounds having two to three hydroxyl, amino, thiol or carboxyl groups, preferably compounds having two hydroxyl, amino, thiol or carboxyl groups, more preferably diols, having an average molecular weight of ≥500 and ≤5000 g/mol.

Hard segments contribute strength and upper usage temperatures to the TPE-U profiles of properties and soft segments contribute elastic properties and low-temperature flexibility to the material properties of the TPE-U.

Both for the hard segments and for the soft segments, organic diisocyanates used may be aromatic, aliphatic, araliphatic, heterocyclic and cycloaliphatic diisocyanates or mixtures of these diisocyanates (cf. HOUBEN-WEYL “Methoden der organischen Chemie”, volume E20 “Makromolekulare Stoffe”, Georg Thieme Verlag, Stuttgart, New York 1987, pages 1587-1593 or Justus Liebigs Annalen der Chemie, 562, pages 75 to 136).

Specific examples include: aliphatic diisocyanates, such as hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and the corresponding isomer mixtures, 4,4′-dicyclohexylmethane diisocyanate, 2,4′-dicyclohexylmethane diisocyanate and 2,2′-dicyclohexylmethane diisocyanate and the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanato-1,2-diphenylethane and 1,5-naphthylene diisocyanate. It is preferable to employ 1,6-hexamethylene diisocyanate, isophorone diisocyanate, dicyclohexylmethane 4,4′-diisocyanate, diphenylmethane diisocyanate isomer mixtures having a 4,4′-diphenylmethane diisocyanate content of >96% by weight and especially 4,4′-diphenylmethane diisocyanate and 1,5-naphthylene diisocyanate. These diisocyanates may be used singly or in the form of mixtures with one another. They may also be used together with up to 15% by weight (based on the total amount of diisocyanate) of a polyisocyanate, for example triphenylmethane 4,4′,4″-triisocyanate or polyphenylpolymethylene polyisocyanates. Particularly preferred organic diisocyanates are for example 4,4′-diphenylmethane diisocyanate, hydrogenated 4,4′-diphenylnethane diisocyanate, 2,4-tolylene diisocyanate or a mixture of at least two thereof.

The preferred short-chain diols having a molecular weight of 60 to 500 g/mol are preferably aliphatic diols having 2 to 14 carbon atoms, for example ethanediol, 1,2-propanediol, 1,3-propanediol, 1,4-butanediol, 2,3-butanediol, 1,5-pentanediol, 1,6-hexanediol, diethylene glycol and dipropylene glycol. Also suitable, however, are diesters of terephthalic acid with glycols having 2 to 4 carbon atoms, for example terephthalic acid bis-ethylene glycol or terephthalic acid bis-1,4-butanediol, hydroxyalkylene ethers of hydroquinone, for example 1,4-di(β-hydroxyethyl)hydroquinone, ethoxylated bisphenols, for example 1,4-di(β-hydroxyethyl)bisphenol A, (cyclo)aliphatische diamines, such as isophoronediamine, ethylenediamine, 1,2-propylenediamine, 1,3-propylenediamine, N-methylpropylene-1,3-diamine, N,N′-dimethylethylenediamine and aromatic diamines, such as 2,4-tolylenediamine, 2,6-tolylenediamine, 3,5-diethyl-2,4-tolylenediamine or 3,5-diethyl-2,6-tolylenediamine or primary mono-, di-, tri- or tetraalkyl-substituted 4,4′-diaminodiphenylmethanes. Particular preference is given to using ethanediol, 1,2-propanediol, 1,3-propanediol, 1,4-butanediol, 1,6-hexanediol, ethylene glycol, diethylene glycol, 1,4-di($-hydroxyethyl)hydroquinone or 1,4-di($-hydroxyethyl)bisphenol A. It is also possible to use mixtures of the abovementioned compounds. In addition, it is also possible to add relatively small amounts of triols.

The long-chain compounds having two to three hydroxyl, amino, thiol or carboxyl groups, preferably compounds having two hydroxyl, amino, thiol or carboxyl groups, particularly preferably diols, having a number-average molecular weight of ≥500 and ≤5000 g/mol may be divided into two main groups: polyether diols and polyester diols. The polyether diols are based, for example, on polytetrahydrofuran, polyethylene oxide and polypropylene oxide, and mixtures thereof. The polyester diols are typically based on adipates, for example 1,4-butanediol adipate and 1,6-hexanediol adipate and caprolactone. Cocondensates are likewise possible.

The thermoplastic polyurethane of polymer layer B. preferably comprises a polyether diol. If exclusively polyether diols are used as the polyol component in the production of the TPE-U for the polymer layer B. it is preferable when a cover layer D. is arranged on the side of the polymer layer B. opposite the first carrier layer A.

The production of the TPE-U may employ catalysts that are customary and known in the art. These may be tertiary amines, for example triethylamine, dimethylcyclohexylamine, N-methylmorpholine, N,N′-dimethylpiperazine, 2-(dimethylaminoethoxy)ethanol, diazabicyclo[2.2.2]octane and the like and also in particular organic metal compounds such as titanate esters, iron compounds or tin compounds such as tin diacetate, tin dioctoate, tin dilaurate or the dialkyltin salts of aliphatic carboxylic acids, for example dibutyltin diacetate or dibutyltin dilaurate or the like. Preferred catalysts are organic metal compounds, in particular titanate esters, iron compounds and tin compounds. The total amount of catalysts in the TPE-U may generally be about 0% to 5% by weight, preferably 0% to 2% by weight, based on the total amount of TPE-U.

In addition, the TPE-U may contain auxiliaries and additives up to a maximum of 30% by weight, preferably up to a maximum of 20% by weight, based on the total amount of TPE-U.

Typical auxiliaries and additives are pigments, dyes, flame retardants, stabilizers against aging and weathering effects, plasticizers, lubricants and demoulding agents, fungistats and bacteriostats and fillers, and mixtures thereof.

Examples of lubricants are fatty acid esters, metal soaps thereof, fatty acid amides, fatty acid ester amides and silicone compounds. Additives preferably also used in the TPE-U include antiblocking agents, inhibitors, stabilizers against hydrolysis, light, heat and discoloration, flame retardants, dyes, pigments, inorganic and/or organic fillers, for example polycarbonates, and also plasticizers and reinforcers. Reinforcers are in particular fibrous reinforcing materials such as for example inorganic fibres which are produced by prior art methods and may also be sized. Further information about the auxiliaries and additives mentioned may be found in the specialist literature, for example in the monograph by J. H. Saunders and K. C. Frisch “High Polymers”, Volume XVI, Polyurethanes, Part 1 and 2, Interscience Publishers 1962/1964, in “Taschenbuch fnr Kunststoff-Additive” by R. Gächter and H. Müller (Hanser Verlag Munich 1990) or in DE-A 29 01 774.

The TPE-U comprises the individual additives preferably in a range from 1% to 25% by weight, more preferably in a range from 2% to 20% by weight, particularly preferably in a range from 3% to 15% by weight, based on the total amount of TPE-U.

Suitable TPE-U are for example commercially available under the trade names Desmopan™ Elastollan™, Pellethane™, Estane™, Morthane™ or Texin™.

The multilayer construction preferably comprises at least two polymer layers B., a first polymer layer B. and a further polymer layer B. The first polymer layer B. of the multilayer construction according to the invention preferably comprises at least one TPE-U, preferably a TPE-U which has a predominately linear molecular structure whose longer-chain diol component is preferably a difunctional polyether or polyester and particularly preferably a difunctional hydrophilic polyether or polyester and which has a Shore hardness of preferably 70-95 A, particularly preferably 80-90 A, determined according to DIN 53 505.

It is preferable to employ a plurality of polymer layers B. comprising TPE-U with different water permeabilities. This may be achieved via different soft segments and/or modified hard segments of the TPE-U in the individual polymer layers B. For the soft segments an increase in water absorption capacity increases in the sequence: Polyester<polytetrahydrofuran<polyethylene oxide.

Ether-carbonate soft segment units are also suitable. These are characterized by good resistance to hydrolysis. Such materials also have a good a resistance to fungal and microbial attack. Ether soft segment units based on polytetramethylene glycol are particularly preferred.

Modifications of the hard segments are possible for example, such as are realized in the dual hydrophilized Impraperm® types marketed by Covestro AG, and such as are described for example in EP-A 0 525 567 and DE-A 42 36 569.

Production of the at least one further polymer layer B. employs not only the above-described TPE-U but also methyl methacrylate-acrylonitrile-butadiene-styrene polymers (MABS), preferably thermoplastic methyl methacrylate-acrylonitrile-butadiene-styrene polymers.

The MABS preparations employed preferably consist of copolymer containing methyl methacrylate (MMA), acrylonitile, butadiene and styrene. These may be arranged in alternating blocks and segments or else randomly. Particular preference is given to grafted copolymers with blocks of MMA grafted onto units of terpolymers of acrylonitrile, butadiene and styrene or else elastic copolymers of butadiene and styrene.

The components TPE-U and MABS are homogeneously miscible in the melted state but form a plurality of phases upon cooling/solidification due to decreasing miscibility. After solidification of the melt the MABS units are present in rigid domains. These thermally initiable changes in properties may be performed repeatedly and thus allow numerous process steps with these materials.

The employed MABS copolymers in the TPE-U matrix have a gloss-reducing effect in the forming into thin-walled films, especially in blown film extraction.

Preference is given to the use of mixtures of different TPE-U based on different ethers or esters, particularly preferably a mixture of different TPE-U based on ethers or esters, of which at least one TPE-U has a soft segment molecular weight distribution that allows formation of crystalline superstructures. It is particularly preferable to use mixtures of different TPE-U based on different ethers.

Production of the further polymer layer B. preferably employs mixtures of the thermoplastic polyurethanes and the thermoplastic MABS copolymers. If required the phase separation of the blend may be additionally stabilized by adhesion- and phase-promoting substances, in particular modified PE copolymers.

In a preferred embodiment of the multilayer construction the proportion of MABS copolymers in the further polymer layer B. is between 5% and 40% by weight, preferably between 10% and 30% by weight, based on the total weight of the polymer layer B.

Suitable ways of producing the multilayer construction according to the invention particularly include the commonly used thermal forming processes for processing of plastics into multilayered sheetlike structures. These include production by coextrusion, such as the blown film process or the flat film process.

It is preferable to produce the multilayer construction by the blown film process. Coextrusion additionally makes it possible to ensure better composite adhesion of the first polymer layer B. comprising pure TPE-U and the further polymer layer B. composed of mixtures of thermoplastic polyurethanes and thermoplastic MABS.

The multilayer construction may additionally be modified in terms of its surface properties on one or both sides using the known physical and chemical treatment methods, for example corona treatment.

The at least one optional hotmelt adhesive layer C., also referred to simply as adhesive layer C., preferably comprises a thermoplastic polymer. The thermoplastic polymer is preferably selected from the group consisting of a thermoplastic polyurethane (TPE-U), a polyamide, a co-polyamide, a polyester or a co-polyester. The polymer of the hotmelt adhesive layer C. preferably has a softening temperature in a range from 80° C. to 170° C., more preferably from 80° C. to 160° C., particularly preferably from 100° C. to 150° C., determined as specified under methods of measurement. The hotmelt adhesive layer C. preferably has a thickness in the range from 5 to 150 μm, more preferably from 10 to 100 μm, particularly preferably from 20 to 80 μm. It is preferable when the polymer of the adhesive layer C. has a lower softening temperature than the polymer of the polymer layer B. The softening temperature of the polymer of adhesive layer C. is preferably at least 20° C., more preferably in a range from 20° C. to 80° C., more preferably from 30° C. bis 60° C. lower than that of the polymer of polymer layer B. It is preferable when the peel force of the adhesive layer C. with respect to the carrier layer A. is in a range from 0.01 N/cm to 0.1 N/cm, preferably 0.015 N/cm to 0.08 N/cm, more preferably from 0.02 to 0.07 N/cm, particularly preferably from 0.025 to 0.06 N/cm. It is preferable when the adhesive layer C. has a high peel force with respect to textiles such as cotton fabrics, wool fabrics, polymer fabrics, for example fabrics containing polyester, polyurethane, polyacrylate, polyamide, polyterephthalate. It is preferable when the adhesive layer C. has a peel force in a range from 0.1 N/cm to 10 N/cm, preferably 0.2 N/cm to 8 N/cm, more preferably from 0.5 to 6 N/cm, particularly preferably from 0.8 to 5 N/cm with respect to cotton fabrics, wool fabrics or polymer fabrics.

The at least one optional cover layer D. preferably comprises a polymer having a hardness in a range from 50 Shore D to 90 Shore D, preferably from 55 Shore D to 85 Shore D, particularly preferably from 60 Shore D to 80 Shore D, measured according to DIN ISO 7619-1-2012-02. The polymer of the at least one optional cover layer D. is preferably a thermoplastic material, in particular selected from the group consisting of a polyethylene (PE), a polypropylene (PP), a polycarbonate (PC), a polyethylene terephthalate (PET) or a mixture of at least two thereof. The at least one optional cover layer D. comprises the polymer in a range from 70% to 100% by weight, preferably in a range from 80% to 95% by weight, particularly preferably in a range from 85% to 90% by weight, based on the total weight of the respective cover layer D. The cover layer D. preferably has a thickness in a range from 5 to 200 μm, preferably from 10 to 150 μm, more preferably from 15 to 120 μm, particularly preferably from 20 to 110 μm.

If the cover layer D. is present and in contact with the polymer layer B., the separating force between the cover layer D. and the polymer layer B. is preferably in a range from 0.02 to 0.1 N/cm, more preferably 0.03 to 0.08 N/cm.

The at least one optional further polymer layer E. comprises at least one thermoplastic elastomer, preferably a thermoplastic polyurethane (TPE-U), in an amount of ≥70% by weight, preferably ≥80% by weight, particularly preferably ≥90% by weight %, based on the total weight of the polymer layer E. The thermoplastic elastomer of the polymer layer E. is preferably selected from the group of thermoplastic elastomers as described above for the polymer layer B. The thermoplastic elastomer of the further polymer layer E. may contain the same polymer as the polymer layer B. or a different one.

The polymer of the polymer layer E. is a TPE-U as described above for the polymer layer B. It is particularly preferable when the polymer layer E. comprises the same polymer as the polymer layer B., wherein the amount and composition of the additives preferably differs from polymer layer B. The polymer layer E. preferably comprises fewer additives than the polymer layer B. The polymer layer E. preferably comprises not more than half of the additives compared to the polymer layer B. The polymer layer E. preferably has a thickness in a range from 30 to 200 μm, more preferably from 40 to 150 μm, more preferably from >50 to 120 μm, particularly preferably from 55 to 100 μm, very particularly preferably from 60 to 90 μm.

The multilayer construction preferably has the layer sequence selected from the group consisting of A.-B., A.-B.-D., A.-C.-B.-D., A.-E.-B.-D., A.-C.-E.-B.-D.

In a preferred embodiment of the multilayer construction the multilayer construction comprises at least one applied, preferably printed-on, conductor track. The conductor track has a conductor track strand width of 200 μm, a design as shown in FIG. 2 and determined according to process 1) and preferably an electrical resistance ≤10Ω, more preferably ≤5Ω, particularly preferably ≤2Ω.

The at least one conductor track preferably has a thickness in a range from 1 to 20 μm.

It is preferable when the at least one conductor track is produced using a printing process selected from the group consisting of a screen printing process, a rotary printing process, an inkjet printing process, a high-volume printing process, such as gravure printing, offset printing or flexographic printing, or a combination of at least two thereof

In a preferred embodiment of the multilayer construction the at least one conductor track has at least one, preferably at least two, particularly preferably all, of the following properties:
L1. a width of ≥10 μm, preferably in a range from 10 to 1000 μm,
L2. a thickness in a range of ≥1 μm, preferably in a range from 1 μm to 20 μm,
L3. an electrical resistance ≤10Ω, more preferably ≤5Ω, particularly preferably ≤2Ω, at a conductor track strand width of 200 μm, wherein the conductor track has a design as shown in FIG. 2 and was produced according to process 1).

In a preferred embodiment of the multilayer construction the at least one carrier layer A. comprises a polypropylene or a PET or a mixture thereof, preferably a polypropylene.

In a preferred embodiment of the multilayer construction the adhesive layer C. comprises a polymer selected from the group consisting of polyamide, co-polyamide, polyester, co-polyester, TPE-U or a mixture of at least two thereof.

In a preferred embodiment of the multilayer construction the elastomer of the polymer layer B. comprises a thermoplastic polyurethane (TPE-U) constructed from a polyol component and a polyisocyanate component, wherein the polyol component of the TPE-U is preferably selected from the group consisting of polytetrahydrofuran groups, polyethylene glycol ether groups, polyethylene glycol ester groups or a combination of at least two thereof.

It is preferable when the TPE-U of the polymer layer B. comprises exclusively polytetrahydrofuran and/or polyethylene glycol ether groups or exclusively polyethylene glycol ester groups.

In a preferred embodiment of the multilayer construction the employed thermoplastic polyurethane of the polymer layer B. comprises polyethylene glycol ether groups or polyethylene glycol ester groups or a combination of both of these in an amount in a range from 20% to 80% by weight, preferably in a range from 30% to 70% by weight, particularly preferably in a range from 40% to 60% by weight, based on the total weight of the polymer layer B.

In a preferred embodiment of the multilayer construction at least one of the one or more carrier layers A., in particular the carrier layer A., has at least one, preferably at least two, particularly preferably all, of the following properties:
(A1) a thickness in a range from 40 to 150 μm,
(A2) a density in a range from 0.8 to 1.0 g/cm³,
(A3) a hardness in a range from 55 Shore D to 85 Shore D.

In a preferred embodiment of the multilayer construction the polymer layer B. has at least one of the following properties:
(B1) a thickness in a range from 40 to 150 μm,
(B2) a density in a range from 1.0 to 1.5 g/cm³, preferably 1.05 to 1.4 g/cm³, particularly preferably from 1.09 to 1.3 g/cm³ according to DIN EN ISO 1183-1-A,
(B3) a tear propagation resistance in a range from 50 to 130 kN/m, preferably from 60 to 120 kN/m, measured according to DIN ISO 34-1,B,
(B4) a breaking elongation in arrange from 300% to 800%, preferably in a range from 350% to 750%, particularly preferably from 400% to 700%, measured according to DIN EN ISO 527-2016-09,
(B5) a breaking stress in a range from 50 to 80 MPa, preferably from 55 to 75 MPa, measured according to DIN EN ISO 527-2016-09,
(B6) a stress at 50% elongation in a range from 4 to 11 MPa according to DIN EN ISO 527-2016-09,
(B7) a Shore hardness in a range from 70-100 A, preferably from 80-95 A.

In a preferred embodiment of the multilayer construction the multilayer construction has an at least 3-layered construction, preferably comprising a carrier layer A., a polymer layer B., optionally at least one adhesive layer C. between the carrier layer A. and the polymer layer B. The layers A., B. or C. may contain a plurality of plies of the corresponding abovementioned polymers.

In a preferred embodiment of the multilayer construction the multilayer construction has an at least 4-layered construction, preferably comprising a carrier layer A., a polymer layer B., at least one adhesive layer C. and/or a cover layer D., wherein the adhesive layer C., if present, is arranged between the carrier layer A. and the polymer layer B. and the cover layer D., if present, is arranged on the outside of the polymer layer B. The layers A., B. or C. may contain a plurality of plies of the corresponding abovementioned polymers.

In a preferred embodiment of the multilayer construction the multilayer construction is produced by a blown film process.

A further subject of the invention relates to a process for producing the multilayered construction comprising at least the steps of:
(S1) providing a first polymer A) comprising a polypropylene in an amount in a range from 70% by weight to 100% by weight,
(S2) providing a further polymer B) comprising at least one thermoplastic polyurethane in an amount in a range from 70% by weight to 98% by weight,
(S3) optionally providing a further polymer C) comprising at least one thermoplastic polymer distinct from polymer B) in an amount in a range from 80% by weight to 100% by weight,
(S4) optionally providing a further polymer D) comprising at least one polypropylene in an amount in a range from 50% by weight to 100% by weight; preferably from 70% to 90% by weight,
(S5) optionally providing a further polymer E) comprising at least one thermoplastic polymer, preferably a polyether block amide or a TPE-U or both, in an amount in a range from 80% by weight to 100% by weight,
(S6) melting the two polymers A) and B) and optionally C) and/or D) and/or E) in mutually separate extruders,
(S7) supplying the melts of the polymers A) and B) and optionally C) and/or D) and/or E) into an annular die of a blown film plant,
(S8) co-extruding the melts of the polymers A) and B) and optionally C) and/or D) and/or E) in the blown film plant to afford the multilayer construction containing at least one carrier layer A. formed from the polymer A) and a polymer layer B. formed from the polymer B) and optionally adhesive layer C. formed from polymer C), optionally a cover layer D. formed from the polymer D) and optionally a further polymer layer E. formed from the further polymer E) and subsequent cooling of the multilayer construction,
wherein the multilayer construction has a peel force between the carrier layer A. and one of the layers in contact with the carrier layer A. selected from the group consisting of the polymer layer B., the adhesive layer C. or the further polymer layer E. in a range from 0.01 N/cm to 0.1 N/cm, preferably 0.015 N/cm to 0.08 N/cm, more preferably from 0.02 to 0.07 N/cm, particularly preferably from 0.025 to 0.06 N/cm.

The peel force/adhesion between carrier layer A. and polymer layer B. was measured on a strip width of 200 mm based on ASTM F88a.

In a preferred embodiment of the process the carrier layer A. and optionally further layers disposed between carrier layer A. and polymer layer B. are separated from the polymer layer B. and subsequently at least one electrical conductor track is printed onto the polymer layer B. The printing of the at least one conductor track is preferably carried out according to process 1).

A further subject of the invention relates to a use of a multilayer construction according to the invention or a multilayer construction produced by the process according to the invention for producing a sensor, for example for use in medical applications, or a wearable having at least one electrical conductor track. The conductor track preferably has at least one of the following properties:
L1. a width in a range from 10 μm to 1000 μm, preferably in a range from 20 to 800 μm, particularly preferably in a range from 50 to 500 μm, very particularly preferably in a range from 80 to 300 μm,
L2. a thickness of the conductor track after the first printing pass of ≥1 μm, preferably in a range from 1 μm to 20 μm,
L3. an electrical resistance ≤10Ω, more preferably ≤5Ω, particularly preferably ≤2Ω, at a conductor track strand width of 200 μm, a design as shown in FIG. 2 and produced according to process 1.

### EXAMPLES

The films described in the context of the following examples and comparative examples were produced by blown film coextrusion. The screw equipment suitable for digestion of thermoplastic resins is described in terms of its construction for example by Wortberg, Mahlke and Effen in: Kunststoffe, 84 (1994) 1131-1138, by Pearson in: Mechanics of Polymer Processing, Elsevier Publishers, New York, 1985 or by Davis-Standard in: Paper, Film & Foil Converter 64 (1990) pages 84-90. Equipment for forming the melt into films is described inter alia by Michaeli in: Extrusions-Werkzeuge, Hanser Verlag, Munich 1991.

### Starting Materials:

Ether TPE-U: Thermoplastic polyurethane having crystalline superstructures based on polytetrahydrofuran, methylene diphenylene diisocyanate and butanediol as chain extenders and having a Shore A hardness of 87 measured according to DIN 53 505 corresponding to a hardness of 36 Shore D.
Ester TPE-U: Thermoplastic polyurethane having crystalline superstructures based on adipic acid, methylene bisphenyl isocyanate and butanediol as chain extenders and having a Shore A hardness of 93 measured according to DIN 868.
Hydrophilic ether TPE-U:
   Thermoplastic polyurethane based on polyethylene glycol, methylene diphenylene diisocyanate and butanediol as chain extenders and having a Shore A hardness of 83 measured according to DIN 53 505 corresponding to a hardness of 32 Shore D.
Silicate: Diatomaceous earth
PS: Polystyrene
PE compound: Polyethylene comprising additives for improved lubricity and having a density of 0.98 g/cm³
Thermoplastic MABS copolymer:
   Transparent grafted methyl methacrylate-acrylonitrile-butadiene-styrene copolymer having a ball indentation hardness of 75 MPa according to ISO 2039-1 measured at 358 N load over 30 sec
PE-LD: Low density polyethylene without waxes and additional anti-blocking additives and a density of 0.924 g/cm³; Shore D hardness of 48 measured according to DIN 53 505
PP: Polypropylene having a density of 0.9 g/cm³ and a Shore D hardness of 67 measured according to ISO 868
PP compound: Polypropylene compounding product having a density of 0.89 g/cm³

### Example 1

A three-layer blown film die was used to produce a film having a 70 μm-thick carrier layer A. from 100% by weight of a polypropylene having a Shore D hardness of 67.

A co-extruded 100 μm-thick polymer layer B. was produced from a mixture of 80% by weight of a thermoplastic ester TPE-U having a Shore A hardness of 93 and 16% by weight of a thermoplastic MABS copolymer and 4% by weight of a hydrophilic ether TPE-U having a Shore A hardness of 83.

All components used for the respective layer were jointly melted in an extruder.

The extrusion apparatuses were operated at temperatures between 160° C. and 220° C. The melt streams were superimposed in a three-layer blown film head at a processing temperature of 195° C. and discharged through an annular gap die having a diameter of 600 mm. The annular melt web was cooled by subjecting to a flow of air and subsequently laid flat, separated and wound up.

### Example 2

A three-layer blown film die was used to produce a film having a 70 μm-thick carrier layer A. composed of a mixture of 98% by weight of a polypropylene having a Shore D hardness of 67 and 2% by weight of PE compound.

A 100 μm-thick polymer layer B. facing the carrier layer A. was produced from a mixture of 80% by weight of a thermoplastic ether TPE-U having a Shore A hardness of 87 and 16% by weight of a thermoplastic MABS copolymer and 4% by weight of a hydrophilic ether TPE-U having a Shore A hardness of 83.

A 70 μm-thick cover layer D. was produced from a mixture of 98% by weight of PP compound and 2% by weight of PE compound and after extrusion was disposed on the side of the carrier layer A. opposite the polymer layer B.

All components used for the respective layer were jointly melted in an extruder.

The extrusion apparatuses were operated at temperatures between 160° C. and 220° C. The three melt streams were superimposed in a three-layer blown film head at a processing temperature of 195° C. and discharged through an annular gap die having a diameter of 600 mm. The annular melt web was cooled by subjecting to a flow of air and subsequently laid flat, separated and wound up.

### Comparative Example 1

A three-layer blown film die was used to produce a film having a 100 μm-thick polymer layer B. composed of a mixture of 95% by weight of a thermoplastic ether TPE-U having a Shore A hardness of 87 and 3% by weight of hydrophilic ether TPE-U and 2% by weight of silicate.

All employed components were jointly melted in an extruder.

The extrusion apparatuses were operated at temperatures between 160° C. and 200° C. The melt streams were superimposed in a three-layer blown film head at a processing temperature of 195° C. and discharged through an annular gap die having a diameter of 500 mm. The annular melt web was cooled by subjecting to a flow of air and subsequently laid flat, separated and wound up.

### Evaluation of the Films Produced:

All of the films described above were tested for water vapour permeability measured according to DIN 53122-2001-08 at 38° C. and 90% relative humidity and mechanical resilience measured according to DIN EN ISO 527-1-2019-12 (tensile test) and DIN 53515-1990-01 (tear propagation resistance). The peel force/adhesion between carrier layer A. and polymer layer B. was measured on a strip width of 200 mm based on ASTM F88a.

Process 1): To characterize the printability of the polymer layer B. the following steps were performed.
1. Initially the printing of the polymer layer B. was effected with the print layout according to FIG. 2 by screenprinting. The print layout comprised conductor tracks in different widths (also referred to as conductor track strand widths), namely of 200 μm; 150 μm; 120 μm; 100 μm. The printing screen consisted of 120 PET threads per centimetre with a thread thickness of 34 μm. The electrically conductive printing paste LOCTITE ECI 1014 from Henkel AG & Co. KGaA was used.
2. Drying of the print was performed at 120° C. for 15 minutes.
3. Measurement of electrical resistance was undertaken using a multimeter for the respectively printed conductor track (FIG. 2) in the respective conductor track strand width. If no resistance is measurable this indicates incomplete printing of the conductor track. The present setup thus allows the respective film to be printed with functional conductor track strand widths only if these are wider.

TABLE 1
Properties of inventive multilayer constructions
compared to noninventive construction

| | | | Compar- |
|---|---|---|---|
| | Exam- | Exam- | ative |
| Properties of polymer layer B. | ple 1 | ple 2 | Example 1 |
| Thickness [μm] | 100 | 100 | 100 |
| Water vapour permeability | 181 | 306 | 276 |
| DIN 53 122 at 38° C./90% rel. | | | |
| humidity [g/m²] per day | | | |
| Tear propagation resistance | 116 | 61 | 65 |
| (longitudinal) [kN/m] | | | |
| DIN ISO 34-1, B | | | |
| Tear propagation resistance | 117 | 63 | 65 |
| (transverse) [kN/m] | | | |
| DIN ISO 34-1, B | | | |
| Breaking stress (longitudinal) [MPa] | 70 | 73 | 65 |
| DIN EN ISO 527-2016-09 | | | |
| Breaking stress (transverse) [MPa] | 64 | 67 | 65 |
| DIN EN ISO 527-2016-09 | | | |
| Breaking elongation (longitudinal) | 460 | 516 | 540 |
| [%] DIN EN ISO 527-2016-09 | | | |
| Breaking elongation (transverse) [%] | 456 | 507 | 540 |
| DIN EN ISO 527-2016-09 | | | |
| Separation force of polymer layer | 0.027 | 0.036 | N/A |
| B. to carrier layer A. [N/cm] | | | |
| Width of conductor track strand* | ≥150 | ≥120 | >200 |
| printed on polymer layer B. from | | | |
| which an electrical resistance can be | | | |
| measured [μm] | | | |
| Electrical resistance [Ω] of | 0.41 | 0.42 | Not |
| conductor track strand* printed on | | | detectable |
| polymer layer B. at a width of 200 | | | with |
| μm | | | process 1) |

*Printed with LOCTITE ECI 1014 ink from Henkel AG & Co. KGaA with screen composed of 120 PET threads per centimetre and a thread thickness of 34 μm

The inventive films from examples 1 and 2 are markedly superior to the known films from comparative example 1. The inventive film construction in examples 1 and 2 markedly reduces gloss at all measurement angles relative to comparative example 1.

The peel force between the carrier film and the TPE-U layers and the coefficient of friction are similarly good for all multilayer constructions.

The inventive films from examples 1 and 2 are markedly superior to the known films from comparative example 1 with regard to the electrical resistance. The inventive film construction in examples 1 and 2 achieved a marked reduction in electrical resistance in the case of a conductor track strand width of 200 μm, a design as shown in FIG. 2 and production according to process 1.

### Methods of Measurement:

Softening temperature: based on standard EN ISO 60335-1:2020-08

Kofler bench used: Manufacturer: Wagner & Munz, Instrument: Heating bench, Type: WME Procedure: 4 film strips of about 25 cm in length and about 4 mm in width are cut from the film to be tested and placed on the Kofler heating bench such that the length of the film strips are positioned over the various heating zones of the preheated heating bench. After about 2 minutes the measurement is performed by lifting the sample from the heating surface using tweezers and then slowly, starting from the lowest to the highest temperature, peeling it off in an upwards direction at an approximately 900 angle to the Kofler heating bank. At the point where the film tears and the remainder of the film remains adhering to the heating bank the softening point may be directly read off from the heating bench.

Evaluation: of 4 determined values of a measurement series on the same material the lowest and the highest values are reported as a softening range, for example 110-113° C.

Peel force/adhesion between two layers (for example carrier layer A. and polymer layer B.) based on ASTM F88 (process a) and/or DIN 53357:1982-10 (process A) on a strip width of 200 mm Peel force measurements were performed on an INSTRON® 5564K4491 instrument from INSTRON®, Dannstadt, Germany with a 10 N load cell under standard climatic conditions of 23° C. and 50% relative humidity at standard pressure. The employed software on the instrument was Bluehill V3.66.4160 (N). The clamping jaws had a width of 50 mm. The measurements had an accuracy of 1%. The jaw spacing was set to 25 mm, the measuring distance was 200 mm and the test speed was 300 mm/min.

Prior to the actual measurement the multilayer construction to be tested was stored under the abovementioned conditions for at least 16 hours in a climate controlled chamber. 3 test specimens were cut out from the film of the multilayer construction to be tested in the film running direction using a template (200*250 mm). The cut-out sections were distributed over the entire film width and the test specimens had no kinks or folds and had smooth cut edges. The layers of the test specimen for which the peel force should be determined were on a narrow side separated from one another by about 30±1 mm, i.e. pre-separated over this section. The pre-separation was performed mechanically, preferably by hand. The polymer layer A. was thus pre-separated from the adjacent polymer layer B. or adhesive layer C. or polymer layer E. and bonded to a 250 mm-wide metal rail provided with a 200 mm-wide double-sided adhesive strip from Tesa, Germany (Tesa® 4965 PP19 or similar acrylate adhesive tapes). The remaining multilayer construction was placed on the polymer layer A. with the layer previously in contact with polymer layer A. and bonded to a second metal rail likewise provided with a double-sided adhesive tape from Tesa, Germany (Tesa® 4965 PP19 or similar acrylate adhesive tapes). The second metal rail was clamped into the upper clamping jaw of the INSTRON® 5564K4491 measuring instrument and the first metal rail with the polymer layer A. was placed into the lower clamping jaw. The load cell force was set to 0 but for the second and third measurement the force was not set to 0 again. The film should neither sag nor exert any force on the load cell. The non-separated film end was oriented forward. A metal rod was used to hold the film end at right angles to the tensile direction and the machine was started. The metal rod was passed along such that the right angle was preserved. After a 200 mm measurement path the test was terminated and the measurement diagram was obtained from the instrument. The first and the last diagram quarter were not used for evaluation in the calculation of the peel force. The two middle diagram quarters were used to calculate the average peel force which corresponded to the average tensile force acting on the test specimens.

### FIGURES

FIGS. 1-2 describe preferred embodiments of the multilayer construction and the process for production thereof which should not be considered limiting. In the figures:

FIG. 1a: shows a schematic representation of an inventive multilayer construction having a carrier layer A. and a polymer layer B.

FIG. 1b: shows a schematic representation of an inventive multilayer construction having a carrier layer A. and a polymer layer B. and also an adhesive layer C. and a cover layer D.

FIG. 2: shows a representation of a multilayer construction having electrical conductor tracks;

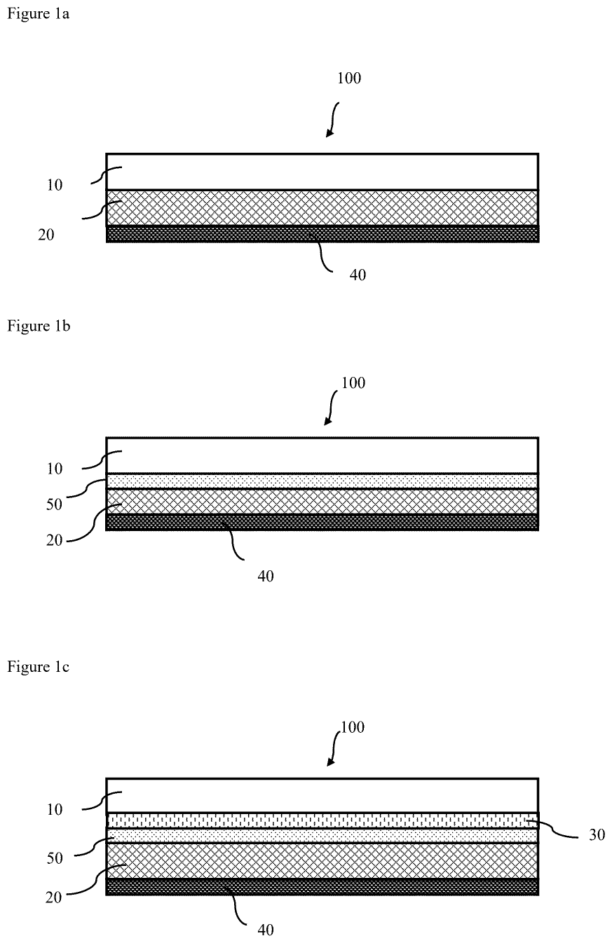

FIG. 1a shows an inventive multilayer construction 100 which comprises a first carrier layer A. 10 and a polymer layer B. 20 produced as described in example 1. A cover layer D. 40 may optionally be arranged on the side of the polymer layer B. 20 which is opposite the carrier layer A. 10.

FIG. 1b shows an inventive multilayer construction 100 which comprises a first carrier layer A. 10 and a polymer layer B. 20 and additionally comprises a further polymer layer E. 50 and optionally a cover layer D. 40.

FIG. 1c shows an inventive multilayer construction 100 which comprises a first carrier layer A. 10 and a polymer layer B. 20 and also optionally comprises an adhesive layer C. 30 and optionally a cover layer D. 40. The multilayer construction 100 moreover comprises a further polymer layer E. 50 which is disposed between the carrier layer A. 10 and the polymer layer B. As mentioned, an adhesive layer C. 30 may also be interposed between polymer layer B. and polymer layer E.

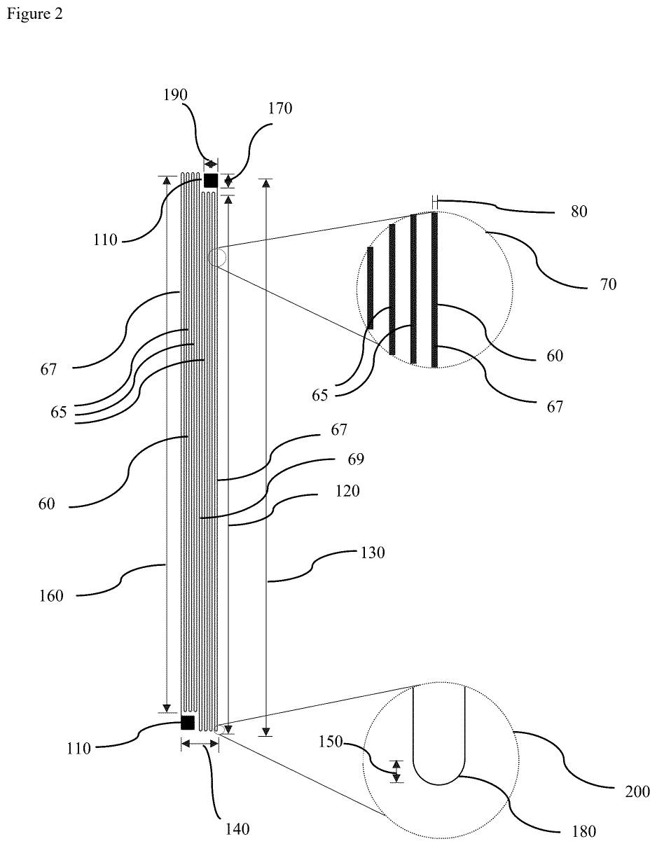

FIG. 2 shows an inventive multilayer construction 100 as produced according to example 1 and subsequently printed with an electrically conductive ink to produce an electrical conductor track 60, as described with reference to example 1 for the examples in table 1. The conductor track 60 has been applied to the polymer layer B. of the multilayer construction 100 in a serpentine pattern. Each strand 65 of the conductor track 60 is connected to an adjacent conductor track strand 65, 67 or 69 via a serpentine loop 180. The outer conductor track strands 67 and the innermost conductor track strand 69 are minimally longer than all further strands 65, wherein the length 160/120 of the respective conductor track strands 65 are in each case 83.6 mm and the inner conductor track strand 69 has a length 130 of 86 mm. The outer two conductor track strands 67 are each connected to a contact 110. The contact 110 has a width 170 of 2 mm and a length 190 of 2 mm. The width 140 of the complete serpentine conductor track 60 is 5.7 mm. An enlargement of a number of conductor track strands 65 and a conductor track strand 67 of the conductor track 60 is apparent in the magnifying glass 70. The width 80 of the conductor track 60 is between 100 and 200 μm with a deviation of not more than 10 μm depending on the embodiment. In the magnifying glass 200 the serpentine or U-shaped intermediate pieces 180 between the conductor track strands 65, 67 and 69 are apparent and the length 150 of the U 180 is about 0.25 mm.

1: A co-extruded multilayer construction comprising at least the following layers:
A. one or more carrier layers A. comprising ≥70% by weight, of a polymer, based on the total weight of the carrier layer A., having a hardness in a range from 50 Shore D to 90 Shore D, measured according to DIN ISO 7619-1-2012-02, wherein at least one of the one or more carrier layers is configured as outer layer A.,
B. at least one polymer layer B. comprising at least one thermoplastic elastomer, in an amount of ≥70% by weight, based on the total weight of the polymer layer B.,
C. optionally at least one hotmelt adhesive layer C. which is arranged between the carrier layer A. and the polymer layer B.,
D. optionally at least one cover layer D. comprising ≥70% by weight, of a polypropylene based on the total weight of the cover layer D.,
E. optionally at least one further polymer layer E. comprising at least one thermoplastic elastomer, in an amount of ≥70% by weight, based on the total weight of the polymer layer E.,
wherein the co-extruded multilayer construction has at least one of the following properties:
(E1) a layer thickness of the carrier layer A. in a range from 30 to 200 μm,
(E2) a layer thickness of the polymer layer B. in a range from 30 to 200 μm,
(E3) a peel force between the carrier layer A. and one of the layers in contact with the carrier layer A. selected from the group consisting of the polymer layer B., the adhesive layer C. and the further polymer layer E. in a range from 0.01 N/cm to 0.1 N/cm,
(E4) a content of additives, selected from the group consisting of waxes, adhesion promoters, and dyes, in the carrier layer A. in a range from 0% to 15% by weight, based on the total weight of the carrier layer A.,
(E5) a content of additives in the polymer layer B., selected from the group consisting of antiblocking agents, in an amount in a range from 0% to 10% by weight, based on the total weight of the polymer layer B.,
(E6) a hardness of the polymer layer B. in a range from 60 Shore A to 55 Shore D,
(E7) a water vapour permeability of at least the polymer layer B. of ≥400 g/c²d,
(E8) a resistance of a 200 μm-wide conductor track strand produced according to process 1) of ≤10Ω.

2: The multilayer construction according to claim 1, wherein the multilayer construction comprises at least one applied conductor track.

3: The multilayer construction according to claim 2, wherein the at least one conductor track has at least one of the following properties:
L1. a width of ≥10 μm,
L2. a thickness in a range of ≥1 μm,
L3. an electrical resistance ≤10Ω, at a conductor track strand width of 200 μm.

4: The multilayer construction according to claim 1, wherein the at least one carrier layer A. comprises one selected from the group consisting of a polypropylene polymer, a PET, and a mixture thereof.

5: The multilayer construction according to claim 1, wherein the adhesive layer C. comprises a polymer selected from the group consisting of polyamide, co-polyamide, polyester, co-polyester, TPE-U and a combination of at least two thereof.

6: The multilayer construction according to claim 1, wherein the elastomer of the polymer layer B. comprises a thermoplastic polyurethane constructed from a polyol component and a polyisocyanate component, wherein the polyol component of the is selected from the group consisting of polytetrahydrofuran groups, polyethylene glycol ether groups, polyethylene glycol ester groups and a combination of at least two thereof.

7: The multilayer construction according to claim 1, wherein the thermoplastic polyurethane of the polymer layer B. comprises polyethylene glycol ether groups or polyethylene glycol ester groups or a combination of both of these in an amount in a range from 20% to 80% by weight, based on the total weight of the polymer layer B.

8: The multilayer construction according to claim 1, wherein at least one of the one or more carrier layers A., has at least one, of the following properties:
(A1) a thickness in a range from 40 to 150 μm,
(A2) a density in a range from 0.8 to 1.0 g/cm³,
(A3) a hardness in a range from 55 Shore D to 85 Shore D.

9: The multilayer construction according to claim 1, wherein the polymer layer B. has at least one of the following properties:
(B1) a thickness in a range from 40 to 150 μm,
(B2) a density in a range from 1.05 to 1.3 g/cm³, according to DIN EN ISO 1183-1-A,
(B3) a tear propagation resistance in a range from 50 to 80 kN/m, measured according to DIN ISOO 34-1,B,
(B4) a breaking elongation of a 50 μm-thick film in a range from 350% to 800%, measured according to DIN EN ISO 527-2016-09,
(B5) a breaking stress in a range from 50 to 80 MPa, measured according to DIN EN ISO 527-2016-09,
(B6) a stress at 50% elongation in a range from 4 to 11 MPa according to DIN EN ISO 527-2016-09,
(B7) a Shore hardness in a range from 70-100 A.

10: The multilayer construction according to claim 1, wherein the multilayer construction has an at least 3-layered construction, comprising two carrier layers A., a polymer layer B., optionally at least one adhesive layer C. between one of the the one or more carrier layers A.

11: The multilayer construction according to claim 1, wherein the multilayer construction has an at least 4-layered construction, comprising two carrier layers A., a polymer layer B., optionally at least one adhesive layer C. between one of the the one or more carrier layers A., and the polymer layer B.

12: The multilayer construction according to claim 1, wherein the multilayer construction is produced by a blown film process.

13: A process for producing a multilayer construction comprising at least the steps of:
(S1) providing a first polymer A) comprising a polypropylene in an amount in a range from 80% by weight to 100% by weight,
(S2) providing a further polymer B) comprising at least one thermoplastic polyurethane in an amount in a range from 80% by weight to 98% by weight,
(S3) optionally providing a further polymer C) comprising at least one thermoplastic polyurethane in an amount in a range from 80% by weight to 98% by weight,
(S4) optionally providing a further polymer D) comprising at least one thermoplastic polyurethane in an amount in a range from 80% by weight to 98% by weight,
(S5) optionally providing a further polymer E) comprising at least one thermoplastic polymer, in an amount in a range from 80% by weight to 100% by weight,
(S6) melting the two polymers A) and B) and optionally C) and/or D) and/or E) in mutually separate extruders,
(S7) supplying the melts of the polymers A) and B) and optionally C) and/or D) and/or E) into an annular die of a blown film plant,
(S8) co-extruding the melts of the polymers A) and B) and optionally C) and/or D) and/or E) in the blown film plant to afford the multilayer construction containing at least one carrier layer A. formed from the polymer A) and a polymer layer B. formed from the polymer B) and optionally adhesive layer C. formed from polymer C), optionally a cover layer D. formed from the polymer D) and optionally a further polymer layer E. formed from the further polymer E) and subsequent cooling of the multilayer construction,
wherein the multilayer construction has a peel force between the carrier layer A. and one of the layers in contact with the carrier layer A. selected from the group consisting of the polymer layer B., the adhesive layer C. or the further polymer layer E. in a range from 0.01 N/cm to 0.1 N/cm.

14: The process according to claim 13, wherein the carrier layer A. and optionally further layers disposed between carrier layer A. and polymer layer B. are separated from the polymer layer B. and subsequently an electrical conductor track is printed onto the polymer layer B.

15. (canceled)
